(19) United States
(12) Patent Application Publication
(10) Pub. No.: US 2020/0410205 A1
(43) Pub. Date: Dec. 31, 2020

(54) CELL IMAGE PROCESSING DEVICE

(71) Applicant: OLYMPUS CORPORATION, Tokyo (JP)

(72) Inventor: Hitoshi ECHIGO, Kanagawa (JP)

(73) Assignee: OLYMPUS CORPORATION, Tokyo (JP)

(21) Appl. No.: 17/016,462

(22) Filed: Sep. 10, 2020

Related U.S. Application Data
(63) Continuation of application No. PCT/JP2018/010210, filed on Mar. 15, 2018.

(51) Int. Cl. G06K 9/00; G06T 7/66; G06K 9/20; G06F 3/14; G06T 3/00; G06T 7/13

(52) U.S. Cl. CPC G06K 9/0014; G06K 9/00134; G06T 7/66; G06K 9/00147; G06T 2207/30024; G06F 3/14; G06T 3/0068; G06T 7/13; G06T 2207/10056; G06K 9/2054

(57) ABSTRACT

A cell image processing device includes: a processor; a memory; and a display, wherein the processor is configured to: extract regions, as measurement regions, that are common among images of cells being cultured and in which the cells are present; calculate each of center positions of each of the extracted measurement regions; store, in the memory, each of the extracted measurement regions, together with acquisition time information and each of the calculated center positions that are associated with each of the extracted measurement regions; specify any of the stored measurement regions; and switch and display, on the display, the measurement regions that are common with the specified measurement region, in the order that the images were acquired while the measurement regions that are common with the specified measurement region are displayed such that the stored center positions association with the measurement regions are aligned with one another.

### CROSS-REFERENCE TO RELATED APPLICATIONS

This is a continuation of International Application PCT/JP2018/010210 which is hereby incorporated by reference herein in its entirety.

### TECHNICAL FIELD

The present invention relates to a cell image processing device.

### BACKGROUND ART

In the process of producing pluripotent cells, such as ES cells and iPS cells, gene introduction and expression often fail, producing many cells that are not characterized as pluripotent cells. In the application of regenerative medicine, etc., it is necessary to extract only pluripotent cells by removing cells that are not characterized as pluripotent cells.

There are well-known methods, including the qPCR procedure and the immunostaining procedure, for determining whether or not cells have developed into, for example, iPS cells. In those methods, proteins referred to as an undifferentiated marker, such as Oct3/4, Nanog, TRA-1-60, and TRA-1-81, in which pluripotent cells are expressed, are examined (for example, refer to PTL 1).

### CITATION LIST

### Patent Literature

### {PTL 1}

Japanese Unexamined Patent Application, Publication No. 2014-100141

### SUMMARY OF INVENTION

One aspect of the present invention is a cell image processing device including: a processor comprising hardware; a memory; and a display, wherein the processor is configured to: extract regions, as measurement regions, that are common among images of cells being cultured and in which the cells are present, the images being acquired over time; calculate each of center positions of each of the extracted measurement regions; store, in the memory, each of the extracted measurement regions, together with acquisition time information and each of the calculated center positions that are associated with each of the extracted measurement regions; specify any of the stored measurement regions; and switch and display, on the display, the measurement regions that are common with the specified measurement region, in the order that the images were acquired, by using the acquisition time information that is stored in association with each of the measurement regions while the measurement regions that are common with the specified measurement region are displayed such that the stored center positions association with the measurement regions are aligned with one another.

Another aspect of the present invention is a cell image processing method in a cell image processing device that includes a display and a memory, the method including: extracting regions, as measurement regions, that are common among images of cells being cultured and in which the cell are present, the images being acquired over time; calculating each of center positions of each of the extracted measurement regions; storing, in the memory, each of the extracted measurement regions, together with acquisition time information and each of the calculated center positions that are associated with each of the extracted measurement regions; specifying any of the stored measurement regions; and switching and displaying, on the display, the measurement regions that are common with the specified measurement region, in the order that the images were acquired, by using the acquisition time information that is stored in association with each of the measurement regions, wherein in the switching and displaying, displaying the measurement regions that are common with the specified measurement region such that the stored center positions association with the measurement regions are aligned with one another.

Further another aspect of the present invention is a cell image processing device including: a processor comprising hardware; and a memory, wherein the processor is configured to: extract measurement regions that are common among images of a colony being cultured and that correspond to the colony, the images being acquired over time; and store, in the memory, each of the extracted measurement regions, together with acquisition time information that is associated with each of the extracted measurement regions.

### BRIEF DESCRIPTION OF DRAWINGS

FIG. 1 is a block diagram showing a cell image processing device according to one embodiment of the present invention.

FIG. 2 is a diagram showing one example of an image acquired by an observation device in FIG. 1.

FIG. 3 is a diagram showing measurement regions extracted from the image in FIG. 2.

FIG. 4 is a diagram showing one reference example of a moving image that is displayed such that the center positions of measurement regions are not aligned with each other.

FIG. 5 is a diagram showing one example of a moving image that is displayed such that the center positions of measurement regions are aligned with each other.

FIG. 6 is a diagram showing one example of the entire image and a moving image that are displayed together by the cell image processing device in FIG. 1.

FIG. 7 is an overall configuration diagram showing an observation device for acquiring an image.

FIG. 8 is a perspective view showing a portion of an illumination optical system in the observation device in FIG. 7.

FIG. 9A is a side elevational view showing one example of a line light source in the illumination optical system in FIG. 8.

FIG. 9B is a front elevational view of the line light source in FIG. 9A as viewed in the optical-axis direction.

FIG. 10 is a diagram showing another example of the line light source in the illumination optical system in FIG. 8.

FIG. 11 is a diagram showing an objective optical system group of the observation device in FIG. 7.

FIG. 12 is a diagram showing the arrangement of objective optical systems in the objective optical system group in FIG. 11.

FIG. 13 is a diagram showing the arrangement of aperture stops in the objective optical system group in FIG. 11.

FIG. 14 is a diagram showing the arrangement of a line sensor on an image plane of the objective optical system group in FIG. 11.

FIG. 15 is a diagram showing the arrangement of a line light source, a cylindrical lens, and a prism in the illumination optical system in FIG. 8.

FIG. 16 is a diagram for illustrating the operation of oblique illumination.

FIG. 17 is a diagram showing one example of an image of a specimen illuminated by oblique illumination in FIG. 16.

FIG. 18A is a diagram showing one example of a specimen.

FIG. 18B is a diagram showing a two-dimensional image of the specimen in FIG. 18A, i.e., the image being acquired by the observation device in FIG. 7.

FIG. 18C is a diagram showing an image obtained by flipping and joining the images in FIG. 18B.

FIG. 19 is a diagram showing the arrangement of a line light source according to another aspect of the observation device in FIG. 7.

### DESCRIPTION OF EMBODIMENTS

A cell image processing device 200 according to one embodiment of the present invention will now be described with reference to the drawings.

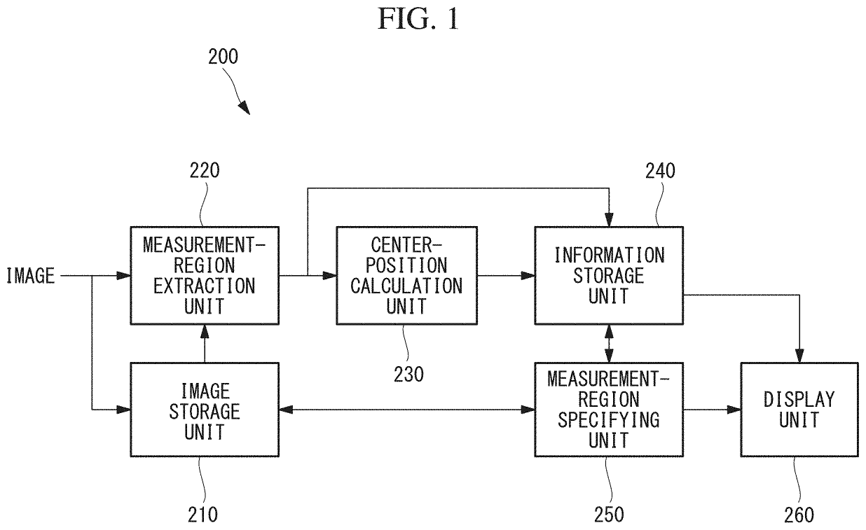

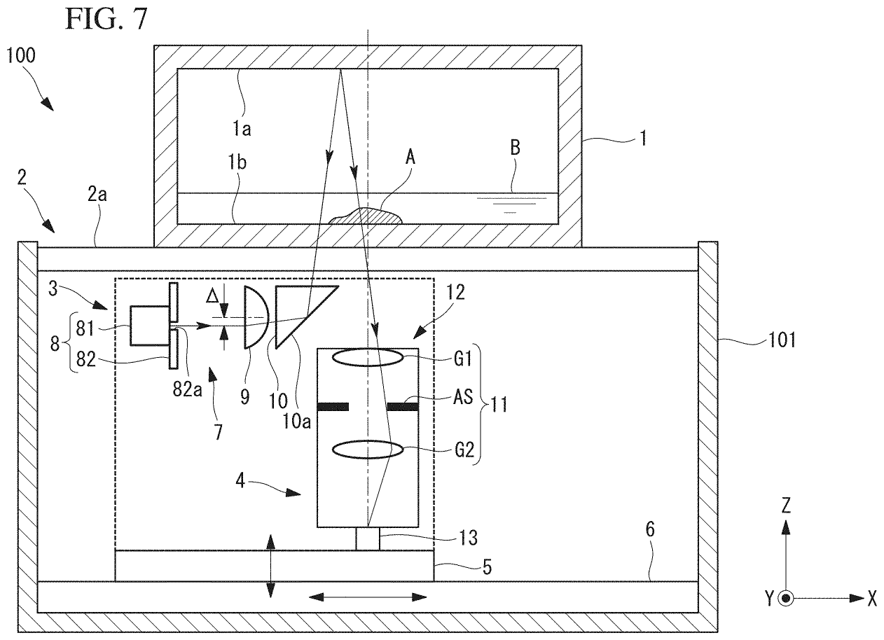

The cell image processing device 200 according to this embodiment is a device for processing a plurality of images acquired by an observation device (refer to FIG. 7) 100 and, as shown in FIG. 1, includes: an image storage unit 210 for storing images that are input from the observation device 100 in a time series manner; a measurement-region extraction unit 220 for extracting a plurality of measurement regions that are common among the images; a center-position calculation unit 230 for calculating the center position of each of the extracted measurement regions; and an information storage unit (storage unit) 240 for storing the extracted measurement regions by associating each of the extracted measurement regions with the calculated center position and the image acquisition time.

In addition, the cell image processing device 200 includes: a measurement-region specifying unit 250 for specifying any of the measurement regions stored in the information storage unit 240; and a display unit 260 for switching and displaying the measurement regions, in other images, that are common with that specified measurement region, in the order that the images of the measurement regions were acquired, by using the image acquisition times that are stored in association with those measurement regions.

The measurement-region extraction unit 220, the center-position calculation unit 230, and the measurement-region specifying unit 250 are configured from a processor, and the image storage unit 210 and the information storage unit 240 are configured from a memory, a storage medium, or the like. In addition, the display unit 260 is configured from a display.

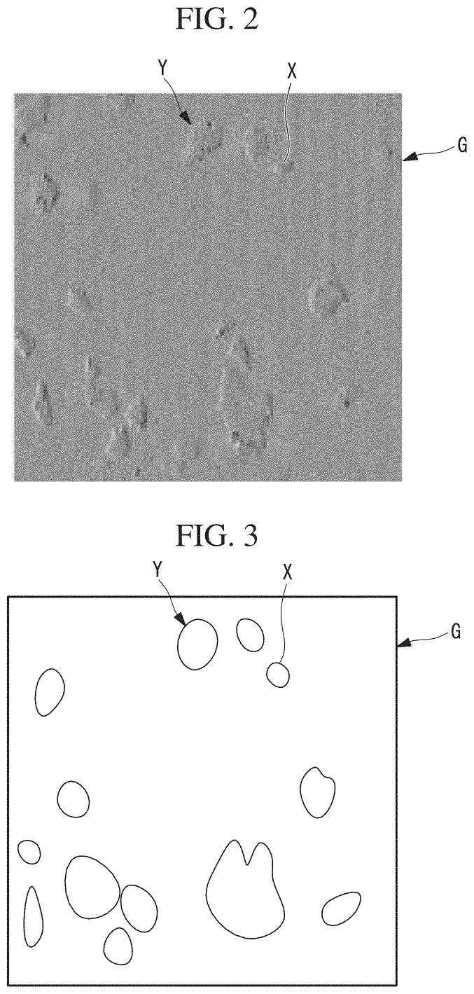

The measurement-region extraction unit 220 sets a plurality of measurement regions in any of the images input from the observation device 100 and extracts, in other images input from the observation device 100, the measurement regions that are common with the measurement regions that have been set. As shown in, for example, FIGS. 2 and 3, the measurement-region extraction unit 220 extracts, in an image G input from the observation device 100, cell regions each including a cell X or a colony Y as measurement regions.

The measurement-region extraction unit 220 recognizes a region surrounded by a closed boundary as a cell X or a colony Y by recognizing the boundary through edge detection or contour tracing and discriminates between the cell X and the colony Y from the size thereof.

In this case, cells X located close to one another among images G and colonies Y located close to one another among the images G may be estimated as the same cell-X region and the same colony-Y region, respectively, or may extract common measurement regions from the images G by performing matching processing among the images G.

The center-position calculation unit 230 calculates the coordinates of the center position of each of the measurement regions that have been extracted by the measurement-region extraction unit 220, on the basis of the center of gravity of the measurement region or the intersection of centerlines in two arbitrary directions of the measurement region.

Information on image acquisition times is attached to the images G that have been sent from the observation device 100.

After a plurality of measurement regions that should be stored have been extracted and the center position of each of the measurement regions has been calculated, the information storage unit 240 stores the extracted measurement regions in association with the coordinates of the center positions and the image acquisition times attached to the measurement regions.

While any of the images G stored in the image storage unit 210 is displayed on the display unit 260, the measurement-region specifying unit 250 allows an observer to specify, on the image G being displayed, a measurement region including a cell X or a colony Y to be observed. It is advisable that a measurement region be specified via a GUI on the image G being displayed. The image G displayed when a measurement region is to be specified may be predetermined or may be selected by the observer. When a measurement region including a cell X or a colony Y is specified, the measurement regions, in other images G, that are common with that specified measurement region are read out from the information storage unit 240 together with the associated center positions and image acquisition times.

The display unit 260 switches and displays the read out measurement regions at prescribed time intervals, in chronological order of image acquisition time, i.e., in the order that the images of the measurement regions were acquired. In this case, the display unit 260 displays the measurement regions so that the center positions of the measurement regions are aligned with one another.

The operation of the cell image processing device 200 according to this embodiment with the above-described structure will be described below.

When images G of the culture surface in a container (culture container) 1 are time-sequentially acquired at predetermined time intervals by the observation device 100, the acquired images G are sent to the cell image processing device 200 together with information on the image acquisition times. The images G that have been sent to the cell image processing device 200 and information on the image acquisition times are stored in the image storage unit 210.

According to the cell image processing device 200 of this embodiment, the measurement-region extraction unit 220 extracts measurement regions from any of the images G that have been sent and extracts, from other images G, the measurement regions that are common with those extracted measurement regions. When measurement regions are extracted, the center-position calculation unit 230 calculates the coordinates of the center position of each of the measurement regions. Each of the extracted measurement regions is stored in the information storage unit 240 in association with the coordinates of the center position and information on the image acquisition time.

Then, the observer selects any of the images G, and when the observer specifies any of the measurement regions by means of the measurement-region specifying unit 250 while the selected image G is being displayed on the display unit 260, the measurement regions, in other images, that are common with that specified measurement region are read out from the information storage unit 240. The read out measurement regions are displayed on the display unit at prescribed time intervals in chronological order of image acquisition time, i.e., in the order that the images of the measurement regions were acquired.

In other words, the cell image processing device 200 according to this embodiment affords an advantage in that cell regions that each include a cell X or a colony Y and that have been extracted as measurement regions are displayed in the form of a moving image that is played back by advancing frames in the temporal axis direction, thereby making it possible to easily confirm how the shapes of the extracted cell regions change in the process of culturing. Compared with a static image, a moving image that is played back by advancing frames provides a larger amount of information, thereby helping single out a particular cell X with high accuracy.

In particular, the cell image processing device 200 according to this embodiment affords an advantage in that, even if the size of a colony Y is small, a cell X can be singled out with high accuracy by confirming a change in the shapes of cell regions in the process of culturing.

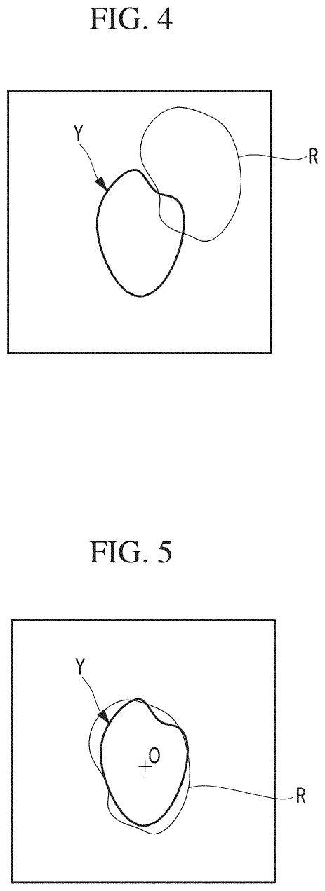

In addition, in this embodiment, the measurement regions are switched and displayed on the display unit 260 at prescribed time intervals in the order that the images of the measurement regions were acquired such that the center positions of the measurement regions are aligned with one another. Therefore, the measurement regions can be observed more easily by minimizing displacement between switched measurement regions. More specifically, it would be difficult to confirm the change in the shape of a measurement region R displayed at the time of switching if the measurement region R were displaced greatly, as shown in FIG. 4. However, because this embodiment prevents the measurement region R from being displaced greatly by aligning the measurement regions with respect to a center position O, as shown in FIG. 5, an advantage is afforded in that a change in the shape of the measurement region R can be confirmed more easily.

Note that although this embodiment includes the display unit 260 for switching and displaying measurement regions that are common among a plurality of images G that have been acquired in a time-series manner, in the order that the images of the measurement regions were acquired, the display unit 260 is not essential. In short, merely by extracting common measurement regions and then storing the extracted measurement regions in the information storage unit 240 such that the extracted measurement regions are associated with time information, the measurement regions can be read out from the information storage unit 240 and displayed in the form of a moving image that is played back by advancing frames.

In addition, the measurement-region extraction unit 220 may determine a measurement region on the basis of a plurality of parameters including the area of the colony Y, a change in the area of the colony Y, the shape of the colony Y, the texture of the colony Y, the height of the colony Y, a change in the height of the colony Y, the growth ability of the colony Y, etc. By doing so, it is possible to select only a colony Y appropriate for a particular purpose as a potential measurement region.

In addition, the selection standards may be changed according to the type of the cell X or the purpose for culturing. By doing so, it is possible to select only a colony Y appropriate for the particular purpose as a potential measurement region. In this case, tables of selection standards may be prepared, so that an appropriate table of selection standards can be selected easily from the prepared tables. In addition, the observer may be allowed to set selection standards as appropriate.

In addition, a colony Y formed as a result of a plurality of colonies Y being united, a colony Y formed of different types of cells, or a region not containing a colony Y may be excluded in advance from areas for setting a measurement region R.

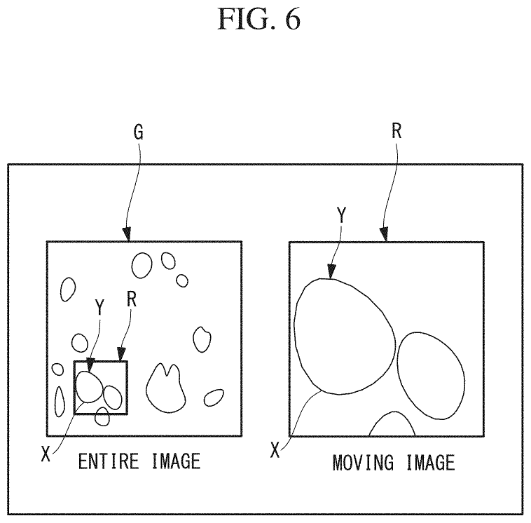

Furthermore, when the observer specifies any measurement region R in any image (entire image) G, the specified measurement region R may be cut out from the entire image G so that a moving image thereof can be displayed separately while the measurement region R is being displayed on the entire image G, as shown in FIG. 6.

Here, one example of the observation device 100 for acquiring an entire image G will be described.

As shown in FIG. 7, the observation device 100 includes: a stage 2 for supporting the container 1 in which a specimen (cells) A is accommodated; an illuminating section 3 for irradiating the specimen A supported on the stage 2 with illumination light; an image acquisition unit 4 for acquiring an image G of the specimen A by detecting, by means of a line sensor 13, illumination light that has passed through the specimen A; a focus adjustment mechanism 5 for adjusting the position of the focal point, on the specimen A, of the image acquisition unit 4; and a scanning mechanism 6 for moving the image acquisition unit 4 in a scanning direction orthogonal to the longitudinal direction of the line sensor 13. The illuminating section 3, the image acquisition unit 4, the focus adjustment mechanism 5, the scanning mechanism 6, and the line sensor 13 are hermetically accommodated in a housing 101 the top surface of which is covered with the stage 2.

In the following description, an XYZ rectangular coordinate system in which the direction along the optical axis of the image acquisition unit 4 (optical axes of objective optical systems 11) is defined as a Z direction, the scanning direction of the image acquisition unit 4 moved by the scanning mechanism 6 is defined as an X direction, and the longitudinal direction of the line sensor 13 is defined as a Y direction is used. As shown in FIG. 7, the observation device 100 is arranged such that the Z direction corresponds to the vertical direction, and the X direction and the Y direction correspond to horizontal directions.

The container 1 is a cell-culturing container, such as a flask or a dish, that is formed of an optically transparent resin as a whole and has a top plate 1a and a bottom plate 1b that are opposed to each other. The specimen A is, for example, cells cultured in a culture medium B. The surface of the inner side of the top plate 1a constitutes a reflecting surface for Fresnel-reflecting illumination light.

The stage 2 includes a horizontally arranged, flat-plate-shaped placement table 2a, so that the container 1 is placed on the placement table 2a. The placement table 2a is formed of an optically transparent material, such as glass, to allow illumination light to pass therethrough.

The illuminating section 3 includes an illumination optical system 7 that is arranged below the stage 2 and that emits line-shaped illumination light obliquely upward, thereby irradiating the specimen A with illumination light from obliquely above the specimen A as a result of the illumination light being reflected obliquely downward at the top plate (reflecting member) 1a.

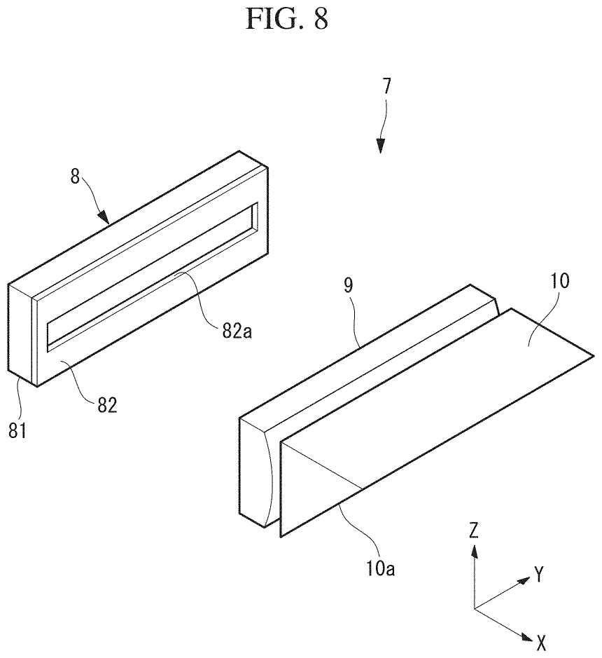

More specifically, as shown in FIG. 8, the illumination optical system 7 includes: a line light source 8 that is arranged laterally with respect to the image acquisition unit 4 and that emits illumination light towards the image acquisition unit 4 in the X direction; a cylindrical lens (lens) 9 for converting, into a collimated beam, the illumination light emitted from the line light source 8; and a prism (deflection element) 10 for deflecting upward the illumination light emitted from the cylindrical lens 9.

The line light source 8 includes: a light source main body 81 having an emission surface for emitting light; and an illumination mask 82 provided on the emission surface of the light source main body 81. The illumination mask 82 has a rectangular opening section 82a having short sides extending in the Z direction and long sides that extend in the Y direction and that are longer than the short sides. As a result of the light emitted from the emission surface passing through only the opening section 82a, illumination light having a line-shaped transverse section (cross section intersecting the optical axis of illumination light) that has a longitudinal direction in the Y direction is generated.

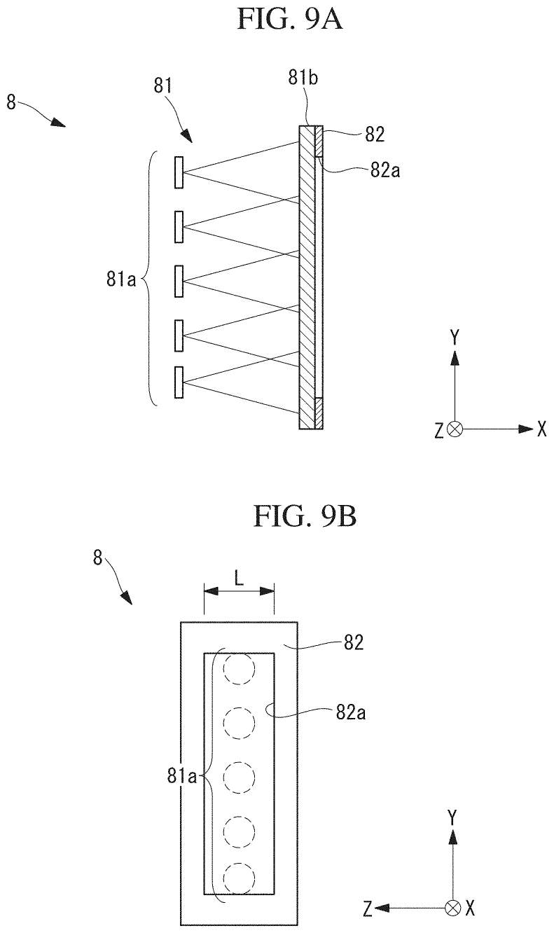

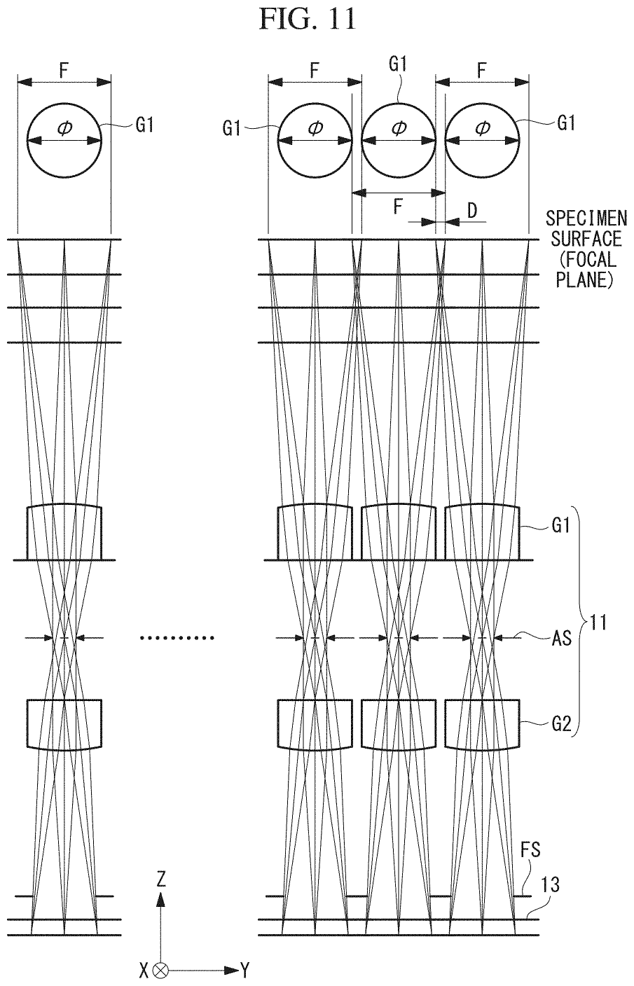

FIGS. 9A, 9B, and 11 show one example of a specific configuration of the line light source 8.

In the line light source 8 shown in FIGS. 9A and 9B, the light source main body 81 includes: an LED row 81a composed of LEDs arranged in a row in the Y direction; and a light-diffusing plate 81b for diffusing light emitted from the LED row 81a. The illumination mask 82 is provided on the surface on the light-emission side of the light-diffusing plate 81b.

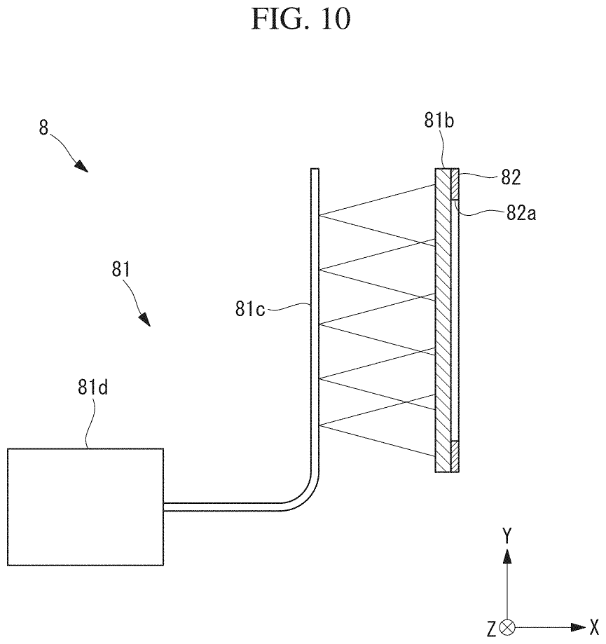

In the line light source 8 shown in FIG. 10, the light source main body 81 includes: a light-diffusing optical fiber 81c; and a light source 81d, such as an LED or an SLD (Superluminescent diode), for supplying light to the optical fiber 81c. The use of the light-diffusing optical fiber 81c allows the light intensity of illumination light to become more uniform than with the use of the LED row 81a.

The cylindrical lens 9 has, on the opposite side from the line light source 8, a curved surface that extends in the Y direction and that bends only in the Z direction. Therefore, the cylindrical lens 9 has refractive power in the Z direction and does not have refractive power in the Y direction. In addition, the illumination mask 82 is located at the focal plane of the cylindrical lens 9 or in the vicinity of the focal plane. By doing so, illumination light in the form of a diverging beam emitted from the opening section 82a of the illumination mask 82 is deflected only in the Z direction by the cylindrical lens 9 and is converted into a beam having a certain dimension in the Z direction (collimated beam on the XZ plane).

The prism 10 has a deflection surface 10a that is tilted by an angle of 45° relative to the optical axis of the cylindrical lens 9 and that deflects upward illumination light that has passed through the cylindrical lens 9. The illumination light deflected at the deflection surface 10a passes through the placement table 2a and the bottom plate 1b of the container 1, is reflected at the top plate 1a, and is incident on the specimen A from above. Thereafter, the illumination light that has passed through the specimen A and the bottom plate 1b is incident on the image acquisition unit 4.

The image acquisition unit 4 includes: an objective optical system group 12 having a plurality of objective optical systems 11 arranged in a row; and the line sensor 13 for acquiring an optical image of the specimen A that has been formed by the objective optical system group 12.

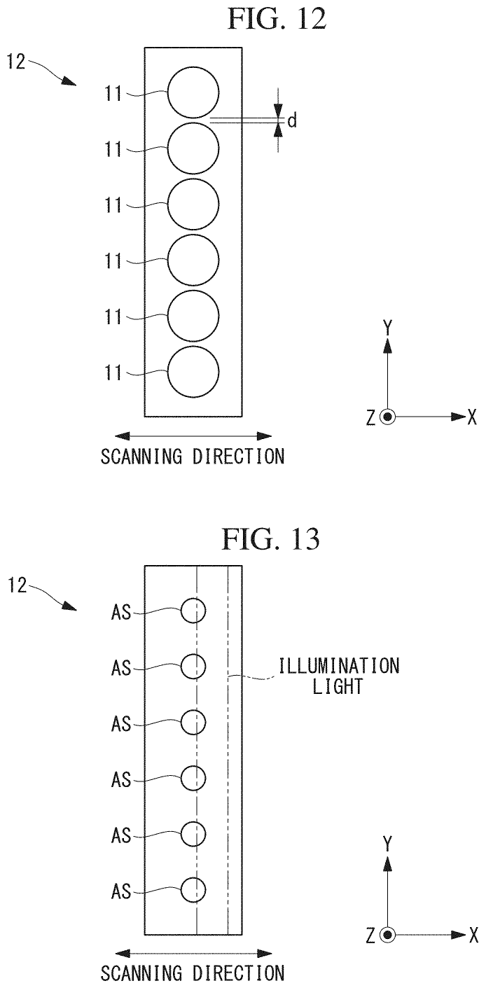

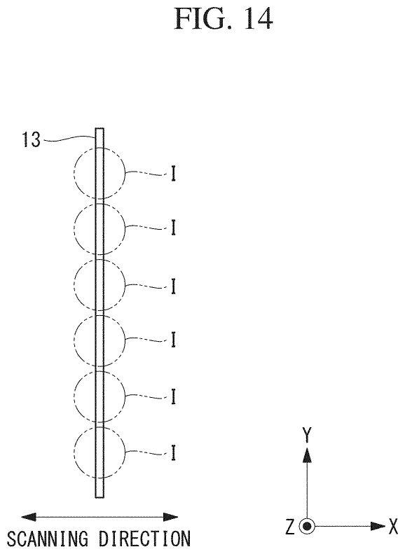

As shown in FIG. 11, each of the objective optical systems 11 includes a first lens group G1, an aperture stop AS, and a second lens group G2 in that order starting from the object side (specimen A side). As shown in FIG. 12, the plurality of objective optical systems 11 have optical axes extending parallel to the Z direction, are arranged in the Y direction, and form optical images on the same plane. Therefore, a plurality of optical images I arranged in a row in the Y direction are formed on the image planes (refer to FIG. 14). The aperture stops AS are also arranged in a row in the Y direction, as shown in FIG. 13.

The line sensor 13 has a plurality of photodetectors arranged in the longitudinal direction and acquires a line-shaped one-dimensional image. As shown in FIG. 14, the line sensor 13 is disposed in the Y direction on the image planes of the plurality of objective optical systems 11. The line sensor 13 acquires a line-shaped one-dimensional image of the specimen A by detecting illumination light that forms the optical images I on the image planes.

A gap d occurs between neighboring objective optical systems 11. In order to obtain a seamless image in the Y direction as an image of the specimen A, the objective optical system group 12 satisfies the following two conditions.

The first condition is that, in each of the objective optical systems 11, the entrance pupil position is located closer to the image side than the first lens group G1, which is located closest to the specimen A side, is, as shown in FIG. 11. This is achieved by disposing the aperture stop AS closer to the object side than the image-side focal point of the first lens group G1 is. When the first condition is satisfied, an off-axis chief ray approaches the optical axis of the objective optical system 11 as the off-axis chief ray travels from the focal plane towards the first lens group G1, and thus, a real field F in a direction (Y direction) orthogonal to the scanning direction becomes larger than the diameter φ of the first lens group G1. Therefore, the fields of view of two neighboring objective optical systems 11 overlap each other in the Y direction, thus forming, on the image planes, optical images of the specimen A free of loss in the fields of view.

The second condition is that the absolute value of the lateral magnification of projection from the object plane onto the image plane of each of the objective optical systems 11 is 1 or less, as shown in FIG. 11. When the second condition is satisfied, the plurality of optical images I formed by the plurality of objective optical systems 11 are arranged on the image planes without overlapping one another in the Y direction. Therefore, the line sensor 13 can acquire an image such that the plurality of optical images I formed by the plurality of objective optical systems 11 are spatially separated from one another. If the projection lateral magnification is larger than 1, two optical images I neighboring in the Y direction overlap each other on the image planes.

Even in the case where the second condition is satisfied, it is preferable that a field stop FS for regulating an illumination-light transmission area be provided in the vicinity of each of the image planes in order to prevent light passing outside the real field F from overlapping a neighboring optical image.

One example of the objective optical system group 12 is shown below.

Position of the entrance pupil (distance to the entrance pupil from the surface, of the first lens group G1, closest to the object side): 20.1 mm.

Projection lateral magnification: −0.756

Real field F: 2.66 mm Lens diameter φ of the first lens group G1: 2.1 mm

Lens spacing between the first lens groups G1 in the Y direction d: 2.3 mm

Field-of-view overlap width D: 0.36 mm (=2.66/2−(2.3−2.66/2))

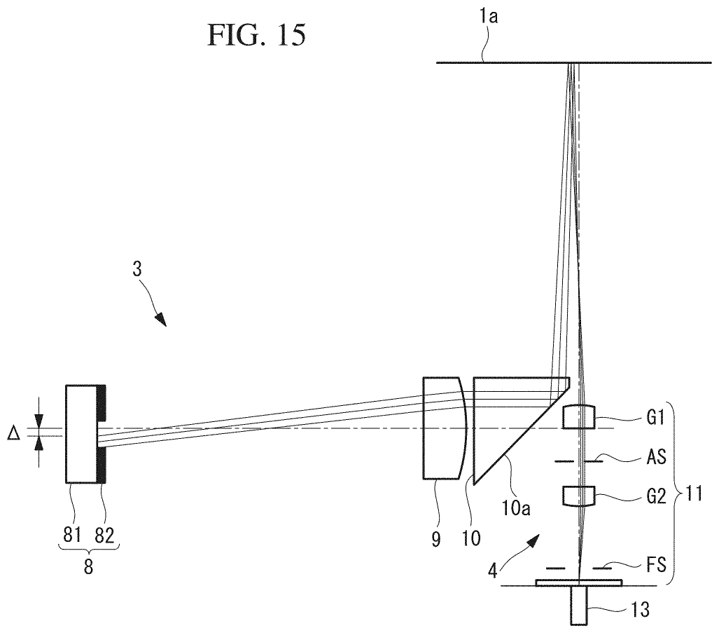

Here, the illuminating section 3 is configured to perform oblique illumination in which the specimen A is irradiated with illumination light in a direction oblique relative to the optical axis of the image acquisition unit 4. More specifically, the illumination mask 82 is located on the focal plane of the cylindrical lens 9 or in the vicinity thereof as described above, and the centers of the short sides of the illumination mask 82 are decentered downward by a distance A relative to the optical axis of the cylindrical lens 9, as shown in FIG. 15. By doing so, illumination light is emitted from the prism 10 in a direction tilted relative to the Z direction in the XZ plane. Then, the illumination light reflected at the substantially horizontal top plate 1a is incident on a specimen surface (focal planes of the objective optical systems 11) obliquely relative to the Z direction in the XZ plane, and the illumination light that has passed through the specimen A is incident obliquely on the objective optical systems 11.

The illumination light converted into a collimated beam by the cylindrical lens 9 has an angle distribution because the illumination mask 82 has a width in the short-side direction. When such illumination light is obliquely incident on the objective optical systems 11, of the illumination light, only a portion that is medial to the optical axis thereof reaches the image planes via the aperture stops AS, whereas the other portion that is laterally outward to the optical axis thereof is blocked by the outer peripheries of the aperture stops AS, as indicated by a double-dotted chain line in FIG. 13.

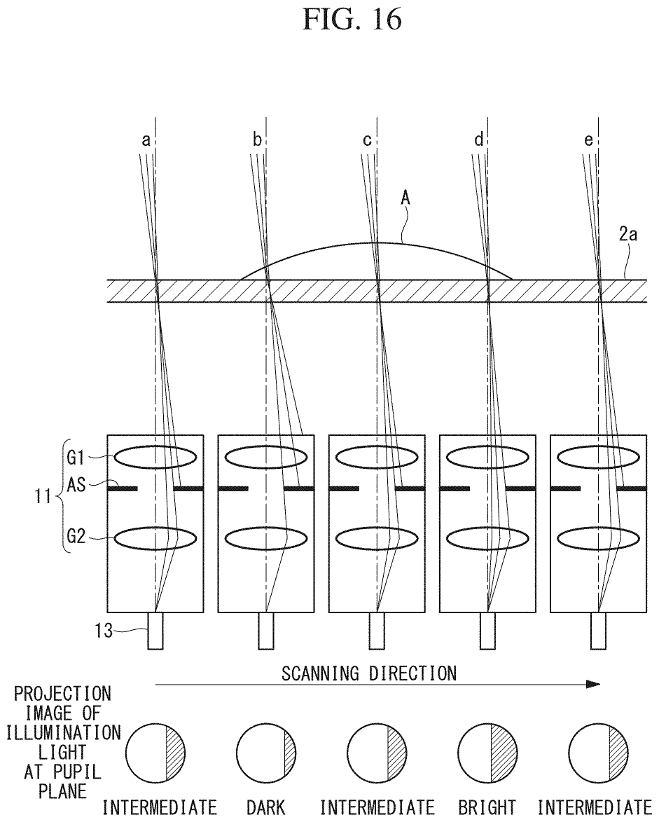

FIG. 16 is a diagram for illustrating the operation of oblique illumination in the case where cells having a high index of refraction are observed as the specimen A. FIG. 16 assumes that the objective optical systems 11 are moved from left to right. When the incident angle of illumination light is equivalent to the captured angles of the objective optical systems 11, light rays a and e that have passed through regions in which the specimen A is not present, as well as a light ray c that has been substantially perpendicularly incident on the top surface of the specimen A, pass through the vicinities of peripheral edges of the entrance pupils, substantially without being reflected, and reach the image planes. Such light rays a, c, and e form optical images with intermediate brightness on the image planes.

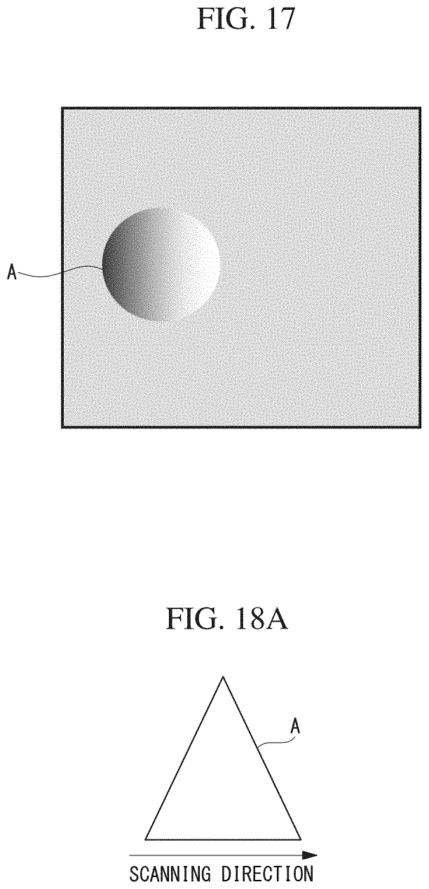

A light ray b that has passed through the left end of the specimen A in FIG. 16 is reflected outward, reaches the outsides of the entrance pupils, and is vignetted by the aperture stops AS. Such a light ray c forms dark optical images on the image planes. A light ray d that has passed through the right end of the specimen A in FIG. 16 is reflected inward and passes through regions further inside than the peripheral edges of the entrance pupils. Such a light ray d forms bright optical images on the image planes. Consequently from the above, it is possible to obtain a high-contrast image of the specimen A that appears stereoscopic as a result of one side thereof being bright and other side thereof being shaded, as shown in FIG. 17.

Regarding the illumination light that is made to be obliquely incident on the objective optical systems 11, in order to achieve illumination light with an angle distribution that causes a portion thereof to pass through the aperture stops AS and the other portion thereof to be blocked by the aperture stops AS, it is preferable that the incident angle of illumination light relative to the optical axis when the illumination light is incident on each of the objective optical systems 11 satisfy conditional expressions (1) and (2) below:

θmin>0.5NA (1)

θmax<1.5NA (2)

Here, θmin represents the minimum value of the incident angle of illumination light relative to the optical axis of each of the objective optical systems 11 (incident angle of the light ray located closest to the optical axis side), θmax represents the maximum value of the incident angle of illumination light relative to the optical axis of each of the objective optical systems 11 (incident angle of the light ray located most radially outward with respect to the optical axis), and NA represents the numerical aperture of each of the objective optical systems 11.

It is experimentally confirmed that a cell image G with high contrast is acquired when conditional expressions (1) and (2) are satisfied in observation performed by using the above-described observation device 100. In order to satisfy conditional expressions (1) and (2), it is preferable that the focal length Fl of the cylindrical lens 9 and the length L of each of the short sides of the opening section 82a of the illumination mask 82 satisfy conditional expression (3) below.

L>(θmax−θmin)Fl (3)

Furthermore, in the case where the angle of deflection of the prism 10 (tilt angle of the deflection surface 10a relative to the optical axis of each of the objective optical systems 11) is 45°, it is preferable that the displacement Δ (decentering distance) of the center positions of the short sides of the illumination mask 82 relative to the optical axis of the cylindrical lens 9 satisfy conditional expression (4) below:

Δ=NA/Fl (4)

In the case where the angle of deflection of the prism is not 45°, Δ is corrected according to the displacement of the angle of deflection with respect to 45°. More specifically, in the case where the angle of deflection is larger than 45°, Δ is increased, and in the case where the angle of deflection is smaller than 45°, A is decreased.

When conditional expressions (1) to (4) are satisfied, it is possible to obtain a high-contrast image G of the specimen A, even though the specimen A is a phase object such as cells. When conditional expressions (1) to (4) are not satisfied, the contrast of the specimen A decreases.

The focus adjustment mechanism 5 moves the illumination optical system 7 and the image acquisition unit 4 in the Z direction in a unified manner by means of, for example, a linear actuator (not shown in the figure). By doing so, it is possible to perform focusing of the objective optical system group 12 onto the specimen A by changing the Z-direction positions of the illumination optical system 7 and the image acquisition unit 4 relative to the stationary stage 2.

The scanning mechanism 6 moves the image acquisition unit 4 and the illumination optical system 7 in the X direction, integrally with the focus adjustment mechanism 5, by means of, for example, a linear actuator for supporting the focus adjustment mechanism 5.

Note that the scanning mechanism 6 may employ a method for moving the stage 2 in the X direction, instead of moving the image acquisition unit 4 and the illumination optical system 7, or may be configured to move, in the X direction, the image acquisition unit 4 and the illumination optical system 7, as well as the stage 2.

Next, the operation of the observation device 100 will be described by way of an example where the specimen A, in the form of cells, being cultured in the container 1 is to be observed.

Line-shaped illumination light emitted in the X direction from the line light source 8 is converted into a collimated beam by the cylindrical lens 9, is deflected upward by the prism 10, and is emitted obliquely upward relative to the optical axis. The illumination light passes through the placement table 2a and the bottom plate 1b of the container 1, is reflected obliquely downward at the top plate 1a, passes through the specimen A, the bottom plate 1b, and the placement table 2a, and is then collected by the plurality of objective optical systems 11. The illumination light that obliquely travels through the interior of each of the objective optical systems 11 is partially vignetted at the aperture stop AS, and as a result of only a portion of the illumination light passing through the aperture stop AS, the illumination light forms a shaded optical image of the specimen A on the image plane.

The optical images of the specimen A formed on the image planes are captured by the line sensor 13 disposed on the image planes, thus acquiring a one-dimensional image of the specimen A. While being moved in the X direction through the operation of the scanning mechanism 6, the image acquisition unit 4 repeats acquisition of a one-dimensional image by means of the line sensor 13. In this manner, a two-dimensional image of the specimen A distributed on the bottom plate 1b is acquired.

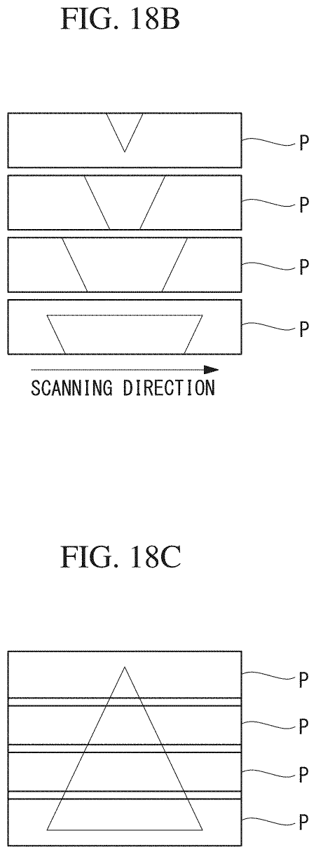

Here, the image formed on the image plane by each of the objective optical systems 11 is an inverted image. Therefore, in the case where the two-dimensional image of the specimen A shown in, for example, FIG. 18A is acquired, a partial image P corresponding to each of the objective optical systems 11 is shown as inverted, as shown in FIG. 18B. In order to correct these inverted images, the process of flipping each of the partial images P in a direction orthogonal to the scanning direction is performed, as shown in FIG. 18C.

In the case where the absolute value of the projection lateral magnification of each of the objective optical systems 11 is larger than 1, the field of view of an edge portion of each of the partial images P overlaps the field of view of an edge portion of a neighboring partial image P. In this case, the process of joining the partial images P by overlapping the edge portions with each other is performed, as shown in FIG. 18C. In the case where the projection lateral magnification of each of the objective optical systems 11 is 1, such a joining process is not required.

As described above, when oblique illumination is used in the line-scanning observation device 100, which acquires a two-dimensional image of the specimen A by scanning the line sensor 13 relative to the specimen A, an advantage is provided in that a high-contrast image can be acquired even for a transparent and colorless phase object, such as cells. Another advantage is also provided in that a compact device can be realized because the illuminating section 3, the image acquisition unit 4, the focus adjustment mechanism 5, and the scanning mechanism 6 are all gathered below the stage 2 by using the top plate 1a of the container 1 as a reflecting member.

Furthermore, because the illuminating section 3, the image acquisition unit 4, the focus adjustment mechanism 5, and the scanning mechanism 6 are all accommodated in the housing below the stage 2 in a hermetically sealed manner, the device can be accommodated in a high-temperature, high-humidity incubator, making it possible to acquire images over time while the specimen A is being cultured in the incubator.

In addition, the device can also be adjusted to the container 1 having a low top plate 1a by the effect of the prism 10 disposed in the vicinity of the objective optical system group 12.

More specifically, in the case where the container 1 having the top plate 1a at a low position is used, it is necessary to make the illumination-light emission position from the illuminating section 3 closer to the optical axis of the objective optical system group 12 in order to satisfy conditional expressions (1) to (4) above. However, it is difficult to dispose the line light source 8 in the vicinity of the objective optical system group 12 due to interference with the lenses, frames, etc. of the objective optical system group 12.

To overcome this problem, the prism 10 is inserted between the placement table 2a and the objective optical system group 12 so as to be disposed at a position that is above the objective optical system group 12 and that is slightly shifted from the optical axis in the radial direction, whereas the line light source 8 is disposed at a position away from the objective optical system group 12 in the horizontal direction, as shown in FIG. 15. By doing so, it is possible to emit illumination light obliquely upward from the vicinity of the optical axis of the objective optical system group 12.

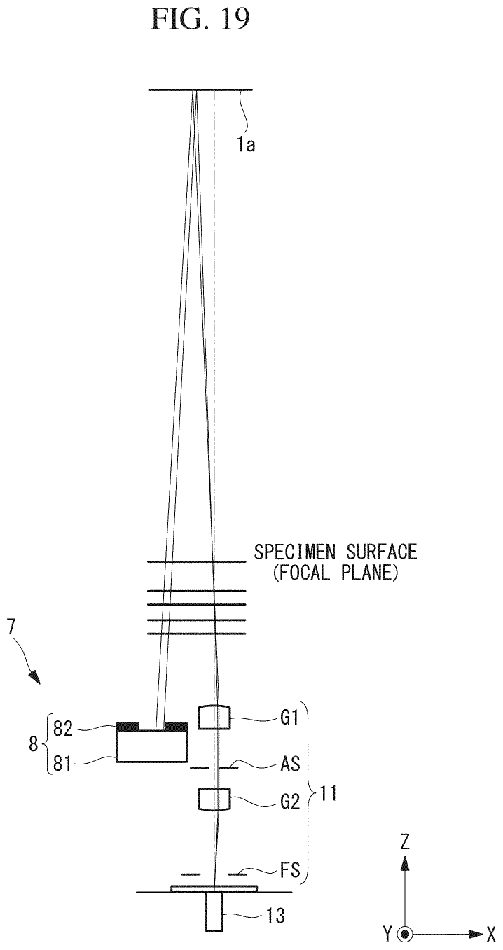

In the case where the container 1 having the top plate 1a at a high position is used, in order to obtain a contrast optical image of the specimen A by oblique illumination, illumination light is emitted obliquely upward from a position away from the optical axis of the objective optical system group 12. Therefore, the prism 10 may be omitted, as shown in FIG. 19, thereby disposing the line light source 8 at a position at which illumination light is emitted obliquely upward from the line light source 8.

Furthermore, if containers 1 with the top plate 1a of the same height are exclusively used, the angle of illumination light incident on the specimen A becomes constant because the relative positional relationship among the surface of the specimen, the reflecting surface (top plate 1a) of the reflecting member, and the illumination optical system 7 does not change. Therefore, in this case, the prism 10 and the cylindrical lens 9 may be omitted, as shown in FIG. 19.

Although the present embodiment uses the top plate 1a of the container 1 as the reflecting member for reflecting illumination light, instead of this, the present embodiment may be configured to employ a method for reflecting illumination light by means of a reflecting member provided above the container 1.

In addition, although, in this embodiment, the display unit 260 shows the growth rate in association with position information by means of colors superimposed on the image G, instead of this, the display unit 260 may show the growth rate by associating the growth rate with position information by means of numerical values.

Although this embodiment has been described by way of an example where a device for acquiring an image in a linear shape is used as the observation device 100, any device capable of acquiring an image of cells X at a plurality of positions or an image of a wide region can be employed as the observation device 100. More specifically, a device for acquiring an image in a square shape may be employed.

The above-described embodiment also leads to the following aspects.

One aspect of the present invention is a cell image processing device including: a measurement-region extraction unit for extracting measurement regions that are common among images of cells being cultured, the images being acquired over time; and a storage unit for storing each of the measurement regions extracted by the measurement-region extraction unit, together with an image acquisition time that is associated with each of the measurement regions.

According to this aspect, when a plurality of images are input, the measurement-region extraction unit extracts a plurality of measurement region that are common among the images. Then, each of the measurement regions extracted by the measurement-region extraction unit is stored in the storage unit in association with the image acquisition time of the image including the measurement region.

By doing so, when any of the measurement regions in any of the images is specified manually by an observer or automatically by the device, measurement regions, in other images, that are common with the specified measurement region can be selected. Then, it is possible to confirm a change in the shape of a cell in the process of culturing by switching and displaying the selected measurement regions in chronological order of the image acquisition time.

More specifically, when the observer identifies a measurement region in which a particular cell, such as a pluripotent cell, is present while looking at an image, the observer extracts cells, in other measurement regions, that exhibit similar changes in the shapes thereof to that of the cell in the identified measurement region, thus allowing the observer to single out a particular cell that is present in the culture container with high accuracy, regardless of the size of a colony.

The above-described aspect may further include: a measurement-region specifying unit for specifying any of the measurement regions stored in the storage unit; and a display unit for switching and displaying the measurement regions that are common with the any of the measurement regions specified by the measurement-region specifying unit, in the order that the images were acquired, by using the image acquisition time that is stored in association with each of the measurement regions.

With this configuration, when any of the measurement regions is specified by the measurement-region specifying unit, the measurement regions, in other images, that are common with the specified measurement region are displayed on the display unit, in the order that the images of the measurement regions were acquired, by using the image acquisition time associated with each of the measurement regions. By doing so, the observer can visually confirm changes in the shapes of cells in the process of culturing in the form of a moving image that is played back by advancing frames. The observer can single out a cell with high accuracy on the basis of a larger amount of information than the amount of information obtained via a static image.

In addition, in the above-described aspect, the measurement-region extraction unit may extract, as the measurement regions, cell regions in which the cells are present, the cell image processing device may include a center-position calculation unit for calculating each of center positions of each of the measurement regions extracted by the measurement-region extraction unit, the storage unit may store the center positions calculated by the center-position calculation unit in association with the measurement regions, and the display unit may display the measurement regions such that the center positions stored in association with the measurement regions are aligned with one another.

With this configuration, each of the cell regions is displayed on the display unit in the form of a moving image that is played back by advancing frames such that the center positions of the cell regions are aligned with one another. This makes it easier to observe the changes in the cell regions by minimizing displacement among the cell regions.

In addition, another aspect of the present invention is a cell image processing device including: a processor; and a memory, wherein the processor extracts measurement regions that are common among images of cells being cultured, the images being acquired over time, and the memory stores each of the extracted measurement regions, together with an image acquisition time that is associated with each of the measurement regions.

### REFERENCE SIGNS LIST

200 Cell image processing device
210 Image storage unit (memory)
220 Measurement-region extraction unit (processor)
230 Center-position calculation unit (processor)
240 Information storage unit (storage unit, memory)
250 Measurement-region specifying unit (processor)
260 Display unit
A Specimen (cell)
G Image
R Measurement region
X Cell (measurement region)
Y Colony (measurement region)

1. A cell image processing device comprising:
a processor comprising hardware;
a memory; and
a display,
wherein the processor is configured to:
extract regions, as measurement regions, that are common among images of cells being cultured and in which the cells are present, the images being acquired over time;
calculate each of center positions of each of the extracted measurement regions;
store, in the memory, each of the extracted measurement regions, together with acquisition time information and each of the calculated center positions that are associated with each of the extracted measurement regions;
specify any of the stored measurement regions; and
switch and display, on the display, the measurement regions that are common with the specified measurement region, in the order that the images were acquired, by using the acquisition time information that is stored in association with each of the measurement regions while the measurement regions that are common with the specified measurement region are displayed such that the stored center positions association with the measurement regions are aligned with one another.

2. The cell image processing device according to claim 1, wherein the processor is configured to switch and display, on the display, the measurement regions that are common with the specified measurement region at prescribed time intervals in chronological order of the acquisition time information.

3. The cell image processing device according to claim 2, wherein the processor is configured to display, on the display, the measurement regions that are common with the specified measurement region in the form of a moving image that is played back by advancing frames in a temporal axis direction.

4. The cell image processing device according to claim 3, wherein the processor is configured to display, on the display, the moving image separately while the specified measurement region is being displayed on an image which includes the specified measurement region.

5. The cell image processing device according to claim 1, wherein the processor is configured to extract regions, as the measurement regions, that each include a cell or a colony.

6. The cell image processing device according to claim 5, wherein the processor is configured to recognize a region surrounded by a closed boundary as a cell or a colony and discriminate between the cell and the colony from a size thereof.

7. The cell image processing device according to claim 6, wherein the processor is configured to extract the measurement regions by estimating cells located close to one another among the images and colonies located close to one another among the images as the same region or by performing matching processing among the images.

8. The cell image processing device according to claim 1, wherein the processor is configured to extract the measurement regions on the basis of parameters of a colony.

9. The cell image processing device according to claim 1, wherein the processor is configured to extract the measurement regions on the basis of tables of selection standards for determining the measurement regions.

10. The cell image processing device according to claim 1, wherein the processor is configured to exclude a colony formed as a result of a plurality of colonies being united, a colony formed of different types of cells, or a region not containing a colony from the measurement regions to be extracted in advance.

11. The cell image processing device according to claim 1, wherein the processor is configured to calculate each of the center positions of each of the extracted measurement regions on the basis of a center of gravity of each of the extracted measurement regions or an intersection of centerlines in two arbitrary directions of each of the extracted measurement regions.

12. A cell image processing method in a cell image processing device that includes a display and a memory, the method comprising:
extracting regions, as measurement regions, that are common among images of cells being cultured and in which the cell are present, the images being acquired over time;
calculating each of center positions of each of the extracted measurement regions;
storing, in the memory, each of the extracted measurement regions, together with acquisition time information and each of the calculated center positions that are associated with each of the extracted measurement regions;
specifying any of the stored measurement regions; and
switching and displaying, on the display, the measurement regions that are common with the specified measurement region, in the order that the images were acquired, by using the acquisition time information that is stored in association with each of the measurement regions, wherein
in the switching and displaying, displaying the measurement regions that are common with the specified measurement region such that the stored center positions association with the measurement regions are aligned with one another.

13. A cell image processing device comprising:
a processor comprising hardware; and
a memory,
wherein the processor is configured to:
extract measurement regions that are common among images of a colony being cultured and that correspond to the colony, the images being acquired over time; and
store, in the memory, each of the extracted measurement regions, together with acquisition time information that is associated with each of the extracted measurement regions.

14. The cell image processing device according to claim 13, wherein the processor is configured to extract the measurement regions on the basis of parameters of a colony.

15. The cell image processing device according to claim 13, wherein the processor is configured to extract the measurement regions on the basis of tables of selection standards for determining the measurement regions.
